(19) United States
(12) Patent Application Publication
(10) Pub. No.: US 2018/0207663 A1
(43) Pub. Date: Jul. 26, 2018

(54) POWERED LIQUID SPRAY APPARATUS TO COAT PIPE JOINTS

(71) Applicant: PIPELINE COATING SERVICES, LLC, Conroe, TX (US)

(72) Inventors: Dennis Roberson, Montgomery, TX (US); Jeff Rollow, Broken Arrow, OK (US)

(21) Appl. No.: 15/659,228

(22) Filed: Jul. 25, 2017

Related U.S. Application Data
(60) Provisional application No. 62/450,120, filed on Jan. 25, 2017.

(51) Int. Cl. B05B 13/04; B05B 7/12; B05D 1/02

(52) U.S. Cl. CPC B05B 13/0436; F16L 58/18; B05D 1/02; B05B 7/12

(57) ABSTRACT

A powered liquid spray apparatus mounts an air gun to a power-driven circumferential ring arranged for rotation about a pipe, with the air gun's nozzle oriented perpendicular to the pipe. The flow of coating through the nozzle is controlled as the power-driven ring rotates about the pipe. If the air gun is mounted parallel to the pipe, the pipe or pipe joint may be coated when skid mounted.

### CROSS-REFERENCE TO CO-PENDING APPLICATIONS

This application claims priority to U.S. Provisional Patent Application No. 62/450,120 for a Powered Liquid Spray Apparatus to Coat Pipe Joints, filed Jan. 25, 2017.

### BACKGROUND

This disclosure is in the field of systems and methods used to apply protective coatings to pipe joints.

One process for applying a protective coating to a pipe joint is to use an air applicator gun, point it directly at the pipe, and manually spray a two-part epoxy coating onto the joint. This manual process is operator-dependent and, as such, does not always apply the coating evenly.

Another process eliminates operator-dependency but uses an expensive multi-component pumping system in connection with a powered ring that sprays the coating. The pumping system requires harsh cleaning materials to clean the nozzles and lines.

### SUMMARY

A powered liquid spray apparatus includes a power-driven circumferential ring that rotates about a horizontal longitudinal axis coaxial to the power-driven circumferential ring and an air gun mounted to the circumferential ring. The air gun includes at least one nozzle oriented perpendicular to the horizontal longitudinal axis.

A powered liquid spray apparatus includes an air gun that is mounted to at least one bracket and has at least one nozzle oriented in a horizontal lateral direction, a coating component in communication with the air gun, means to flow the coating component to the nozzle in a controlled manner, and means to move the air gun relative to a horizontal longitudinal direction.

A method for coating a pipe joint includes mounting an air gun with a nozzle to a powered circumferential ring so that the nozzle is oriented perpendicular to the horizontal longitudinal axis of the ring, rotating the powered circumferential ring about the pipe joint, and flowing coating in a controlled manner through the nozzle.

### BRIEF DESCRIPTION OF THE DRAWINGS

FIG. 1 is an isometric view of an embodiment of a powered liquid spray apparatus.

FIG. 2 is a front elevation view of the embodiment of FIG. 1.

FIG. 3 is a top plan view of the embodiment of FIG. 1.

FIG. 4 is a side elevation view of the embodiment of FIG. 1.

FIG. 5 is front elevation view of an embodiment in which the air gun is mounted perpendicular to the pipe's central longitudinal axis.

FIG. 6 is an isometric view of the embodiment of FIG. 5.

### ELEMENTS AND NUMBERING USED IN THE DRAWINGS

1 Cap screw
2 Cylinder assembly
3 Ratio pack
4 Larger static mixer
5 Spray gun bracket
6 Applicator mounting bar
7 Smaller static mixer
8 Nozzle
9 Spray tube
10 Nozzle mount
11 Elbow
12 Connector
13 Elbow
14 U-bolt
15 Plate
16 Ball valve
17 Support arm bracket
18 Nozzle support
19 Air gun
20 Power-driven circumferential ring
21 Central longitudinal axis of pipe and power-driven circumferential ring
22 Longitudinal axis of mounted air gun

### DETAILED DESCRIPTION

This application incorporates by reference the subject matter of U.S. Provisional Patent Application No. 62/450,120, filed Jan. 25, 2017.

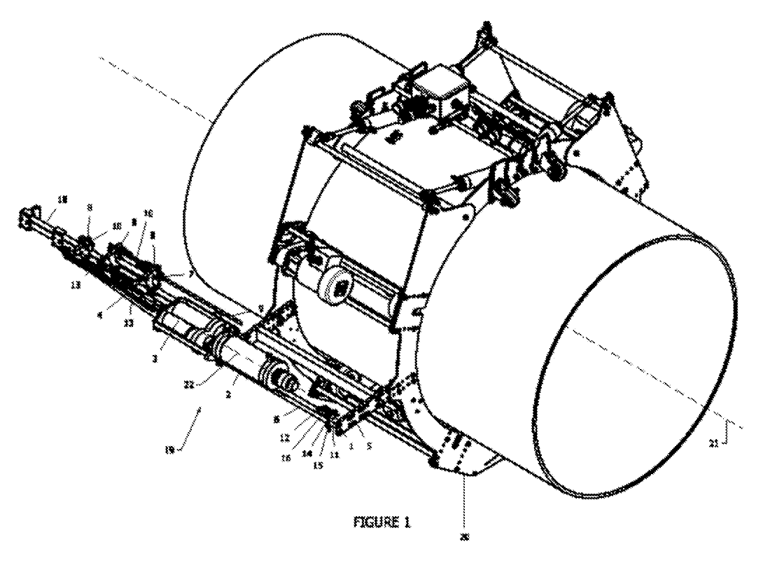

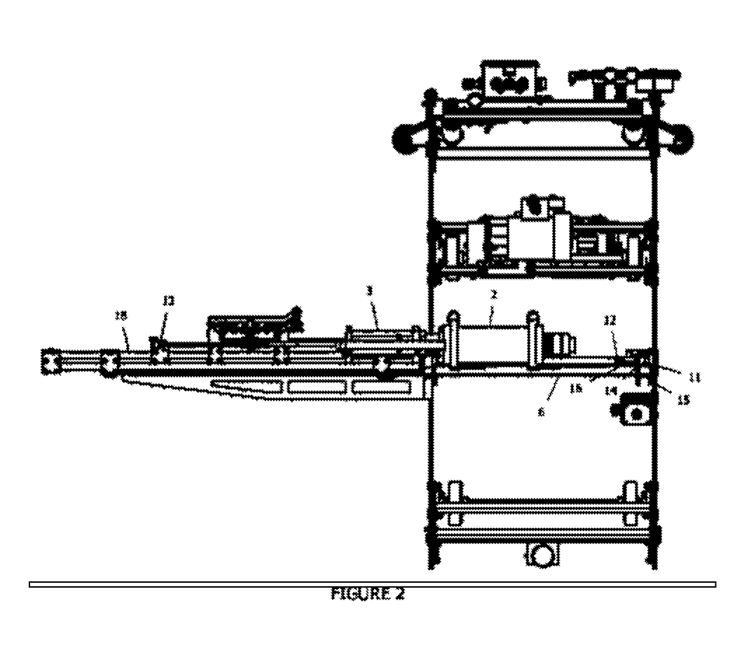

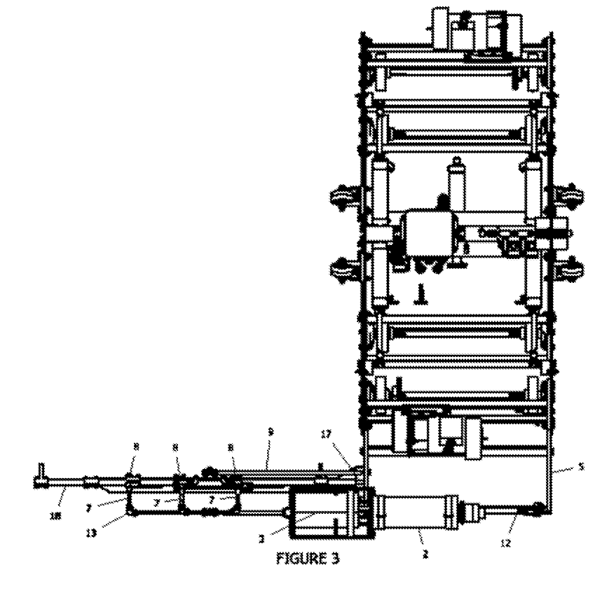

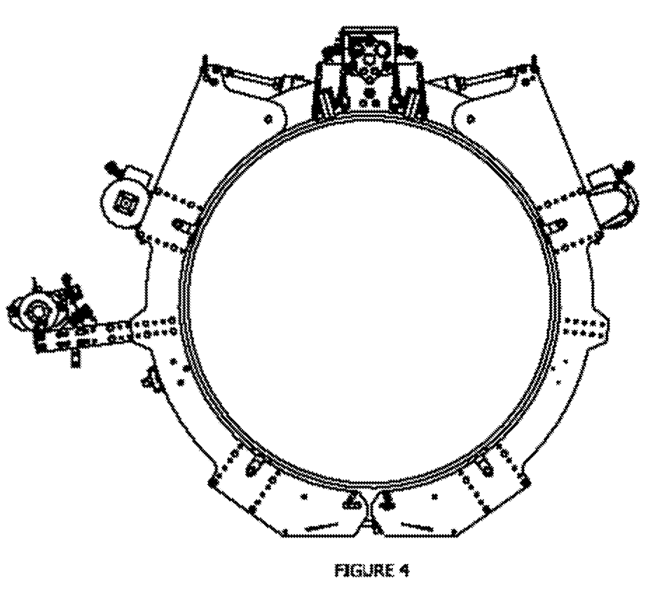

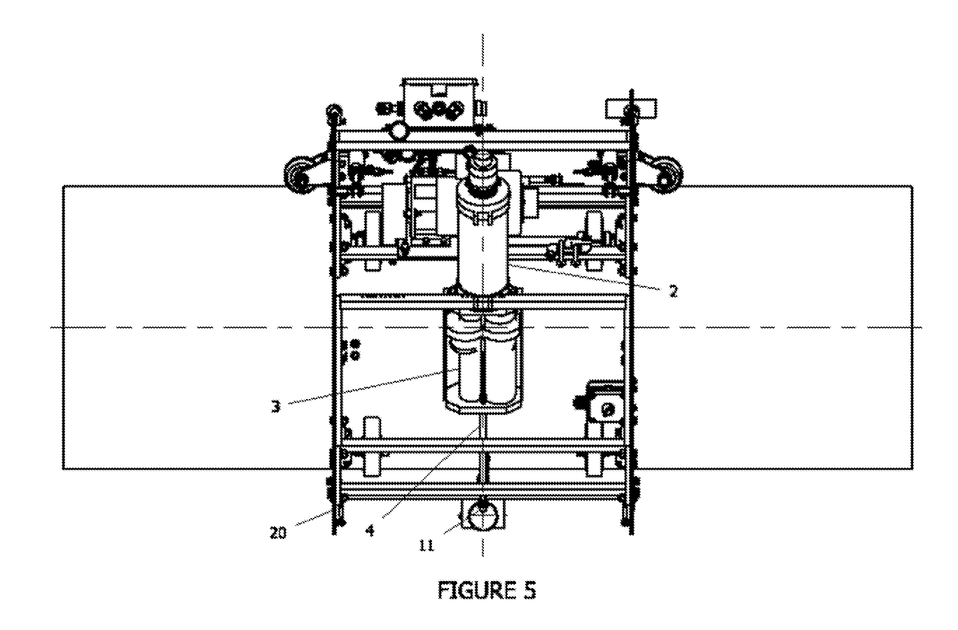

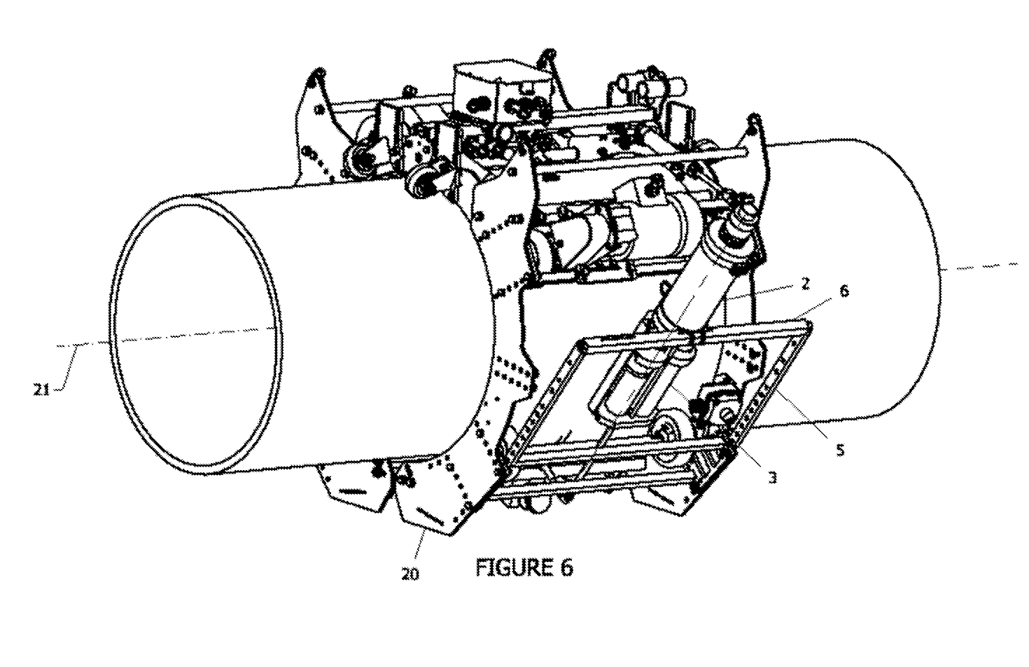

As shown in FIGS. 1-6, an embodiment of a powered liquid spray apparatus to coat pipe joints mounts a modified air-regulated air gun to a power-driven circumferential ring 20 located about the pipe so that the longitudinal axis 22 of the mounted air gun 19 runs parallel or perpendicular (normal) to the central longitudinal axis 21 of the pipe and ring 20 but sprays the coating perpendicular to the pipe. The air gun 19 may be held in a fixed relationship to the pipe or may include a reciprocating head that moves the gun 19 back-and-forth in an axial direction while spraying.

The air gun 19 may be equipped with a plural component ratio pack 3 which contains at least one cylinder or tube of epoxy and a 90° applicator tip or nozzle 8. Multiple cylinders of epoxy may be connected to the same nozzle 8. Alternatively, the ratio pack 3 may contain a plurality of nozzles 8, with each nozzle 8 connected to its own cylinder of epoxy or to a cylinder of epoxy that is shared with at least one other nozzle 8. For example, the ratio pack 3 may have three nozzles 8 and three cylinders of epoxy in a one-to-one ratio.

The power-driven circumferential ring 20 may be an electrically driven PCS™ powder ring (Pipeline Coating Services, Conroe, Tex.) or its equivalent, including hydraulic or pneumatic driven rings. The air gun 19 may be a modified version of the air guns found in U.S. Pat. No. 5,197,635, U.S. Pat. No. 6,290,101 or their equivalent, including but not limited to air guns supplied by Albion Engineering Company, Sulzer Mixpac USA (COX™), Sulzer Mixpac Denmark A/S (Kroger A/S), Wellmade Tool, and Newborn Brothers Co., Inc. The air gun 19 may also be a battery operated gun, including but not limited to those provided by Albion Engineering Company and Meritool LLC. The air gun 19 is modified by removing the trigger and built-in metering valve (if any) and adding an optional cap. A split band may be used to help support the gun 19 in its required parallel orientation.

The flow rate of coating through the air gun 19 and onto the pipe is controlled so that the flow is in a state of statistical process control. The flow is controlled with an externally mounted air regulator (not shown) arranged to provide a consistent force on the air gun's internal piston(s) or plunger(s). This consistent force results in a constant, predictable flow rate of coating, leading to a properly applied coating. Alternatively, a reciprocating force may be applied. The reciprocating flow rate is again controlled so that the flow rate is in a state of statistical process control.

The nozzle 8 applies the coating perpendicular to the pipe in close proximity to the pipe joint being coated. When the air gun 19 is mounted in a parallel orientation, the pipe can be skid-mounted and remain close to the ground during the coating operation. Because of one-time use material packaging, inherent to the air applicator gun style used, labor-intensive and harsh cleaning intensive clean-up is not required. Also, by automating the coating process, operator workload and exposure to the coating materials are reduced.

While the disclosure may be susceptible to various modifications and alternative forms, specific embodiments have been shown by way of example in the drawings and described. This disclosure is not intended to be limited to the particular embodiments disclosed. Rather, the disclosure is to cover all modifications, equivalents, and alternatives falling within the spirit and scope of the disclosure as defined by the following claims. Claim elements designated as “means for” or “step for” are to be interpreted under 35 U.S.C. 112(f). Claims containing elements designated in any other manner are not to be interpreted under 35 U.S.C. 112(f).

What is claimed:

1. A powered liquid spray apparatus comprising:
a power-driven circumferential ring arranged for rotation about a horizontal longitudinal axis coaxial to the power-driven circumferential ring; and
an air gun mounted to the circumferential ring, the air gun including a nozzle oriented perpendicular to the horizontal longitudinal axis.

2. A powered liquid spray apparatus according to claim 1 further comprising the air gun mounted parallel to the horizontal longitudinal axis.

3. A powered liquid spray apparatus according to claim 1 further comprising the air gun mounted perpendicular to the horizontal longitudinal axis.

4. A powered liquid spray apparatus according to claim 1 further comprising means for controlling a flow through the nozzle.

5. A powered liquid spray apparatus according to claim 1 further comprising the air gun being a trigger-free air gun.

6. A powered liquid spray apparatus according to claim 1 further comprising at least one additional nozzle oriented perpendicular to the horizontal longitudinal axis.

7. A powered liquid spray apparatus comprising:
an air gun mounted to at least one bracket, the air gun including at least one nozzle oriented in a horizontal lateral direction;
a coating component in communication with the air gun;
means to flow the coating component to the nozzle in a controlled manner; and
means to move the air gun relative to a horizontal longitudinal direction.

8. A powered liquid spray apparatus according to claim 7 further comprising the air gun oriented in the horizontal longitudinal direction.

9. A powered liquid spray apparatus according to claim 7 further comprising the air gun oriented in the horizontal lateral direction.

10. A powered liquid spray apparatus according to claim 7 wherein the means to move the air gun is a powered ring arranged for rotation about a central longitudinal axis.

11. A method for coating a pipe joint, the method comprising:
mounting an air gun including a nozzle oriented perpendicular to a horizontal longitudinal axis to a powered circumferential ring;
rotating the powered circumferential ring about the pipe joint; and
flowing coating in a controlled manner through the nozzle.

12. A method for coating a pipe joint according to claim 11, further comprising flowing coating in a controlled manner through at least one additional nozzle oriented perpendicular to the horizontal longitudinal axis to the powered circumferential ring.
